(19) United States
(12) Patent Application Publication
(10) Pub. No.: US 2019/0006843 A1
(43) Pub. Date: Jan. 3, 2019

(54) POWER TRANSMISSION DEVICE AND POWER RECEPTION DEVICE

(71) Applicant: KABUSHIKI KAISHA TOSHIBA, Tokyo (JP)

(72) Inventors: Masatoshi SUZUKI, Susono Shizuoka (JP); Yasuhiro KANEKIYO, Yokohama Kanagawa (JP); Tetsu SHIJO, Setagaya Tokyo (JP); Kenichirou OGAWA, Kawasaki Kanagawa (JP); Koji OGURA, Tachikawa Tokyo (JP); Shuichi OBAYASHI, Yokohama Kanagawa (JP); Masaaki ISHIDA, Kawasaki Kanagawa (JP)

(73) Assignee: KABUSHIKI KAISHA TOSHIBA, Tokyo (JP)

(21) Appl. No.: 15/916,911

(22) Filed: Mar. 9, 2018

(30) Foreign Application Priority Data
Jul. 3, 2017 (JP) 2017-130645

(51) Int. Cl. H02J 1/12; H02J 50/12; H02J 5/00

(52) U.S. Cl. CPC H02J 1/12; H02J 5/005; H02J 50/12

(57) ABSTRACT

According to one embodiment, a power transmission device includes: a power transmitter, a frequency control circuit and a voltage control circuit. The power transmitter transmits AC power by causing a coil to generate a magnetic field in response to AC power and coupling the magnetic field to a coil of a power receiver. The frequency control circuit sweeps a frequency of the AC power during the power transmission. The voltage control circuit controls a voltage of the AC power, based on a target condition of a ratio between a voltage of power received by the power receiver and a voltage of the AC power.

### CROSS REFERENCE TO RELATED APPLICATIONS

This application is based upon and claims the benefit of priority from the prior Japanese Patent Application No. 2017-130645, filed on Jul. 3, 2017, the entire contents of which are incorporated herein by reference.

### FIELD

Embodiments described herein relate to a power transmission device and a power reception device.

### BACKGROUND

In a wireless power transfer system, power is wirelessly transferred from a power transmission device to a power reception device. The power transmission device emits magnetic fields caused by a coil to the space. The power reception device couples the magnetic fields to the coil to thereby transmit the power. Such wireless power transmission requires that the intensity of the magnetic fields (radiation magnetic fields) emitted from the power transmission device should be kept equal to or less than a value in conformity with the laws and ordinances typified by the Radio Act.

There is a technique that disperses the radiation magnetic fields on the temporal axis by modulating (sweeping) the frequency in a preset frequency range, in order to suppress the intensity of the radiation magnetic fields. Unfortunately, this technique has a problem that causes the ripples of reception power voltage on the power reception device side. The occurrence of ripples causes increase in load to electric circuits and reduction in battery life.

To address this, there is a technique that controls the amplitude of the input voltage on the transmission side in a manner tracking the modulation of the frequency so as to reduce the reception power voltage on the power reception side. Unfortunately, this technique requires that a data table of the relationship between the frequency and the amplitude of the input voltage should be separately provided, or a state on the power reception side, such as the reception power voltage, should be fed back to the power transmission side at high speed. This requirement causes a problem in that the configuration is complicated.

### BRIEF DESCRIPTION OF THE DRAWINGS

FIG. 1 is a diagram showing an overall configuration of a wireless power transfer system according to a first embodiment;

FIG. 2 is a diagram showing a specific example of a power transmission device;

FIGS. 3A, 3B and 3C each is a diagram showing specific examples of a power transmission resonator and a power reception resonator;

FIG. 4 is a diagram showing a specific example of a power reception device;

FIG. 5 is a diagram showing an example of frequency sweeping;

FIG. 6 is a diagram showing a simulation result;

FIG. 7 is a diagram showing a simulation result;

FIG. 8 is a flowchart of operations of a control circuit according to a first embodiment;

FIG. 9 is a diagram showing a wireless power transfer system according to a second embodiment;

FIG. 10 is a flowchart of operations of a control circuit according to the second embodiment;

FIG. 11 is a diagram showing a wireless power transfer system according to a third embodiment;

FIG. 12 is a diagram showing a flowchart of operations of the wireless power transfer system according to the third embodiment; and

FIG. 13 is a diagram showing a wireless power transfer system according to a fourth embodiment.

### DETAILED DESCRIPTION

According to one embodiment, a power transmission device includes: a power transmitter, a frequency control circuit and a voltage control circuit. The power transmitter transmits AC power by causing a coil to generate a magnetic field in response to AC power and coupling the magnetic field to a coil of a power receiver. The frequency control circuit sweeps a frequency of the AC power during the power transmission. The voltage control circuit controls a voltage of the AC power, based on a target condition of a ratio between a voltage of power received by the power receiver and a voltage of the AC power.

Hereinafter, referring to the drawings, embodiments of the present invention are described.

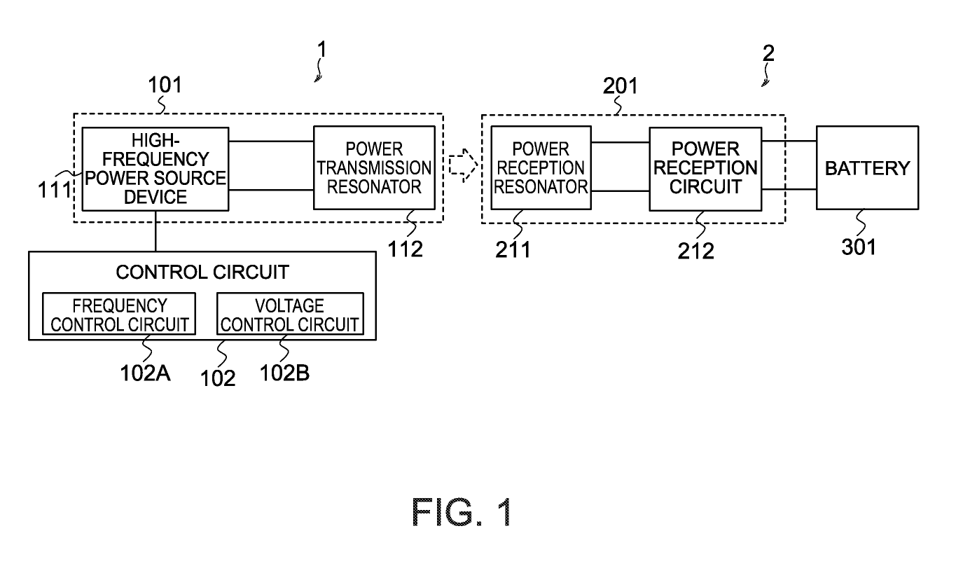

FIG. 1 is a diagram showing an overall configuration of a wireless power transfer system according to an embodiment. This system includes a power transmission device 1 that wirelessly transmits AC power, and a power reception device 2 that receives the AC power. The power transmission device 1 generates AC power from DC power, and causes a power transmission resonator 112 that includes a coil to generate magnetic fields in response to the generated AC power. The power reception device 2 receives the AC power by coupling a power reception resonator 211 that includes a coil to the magnetic fields. The power reception device 2 converts the reception power into DC and charges a battery 301 therewith.

The power transmission device 1 includes a power transmitter 101, and a control circuit 102. The power transmitter 101 includes: a high-frequency power source device 111, which is an AC power source device; and the power transmission resonator 112. The control circuit 102 includes a frequency control circuit 102A, and a voltage control circuit 102B.

The power reception device 2 includes a power receiver 201, and the battery 301. The power receiver 201 includes a power reception resonator 211, and a power reception circuit 212. The battery 301 is herein a part of the power reception device 2, but may be defined as a device separated from the power reception device 2 instead.

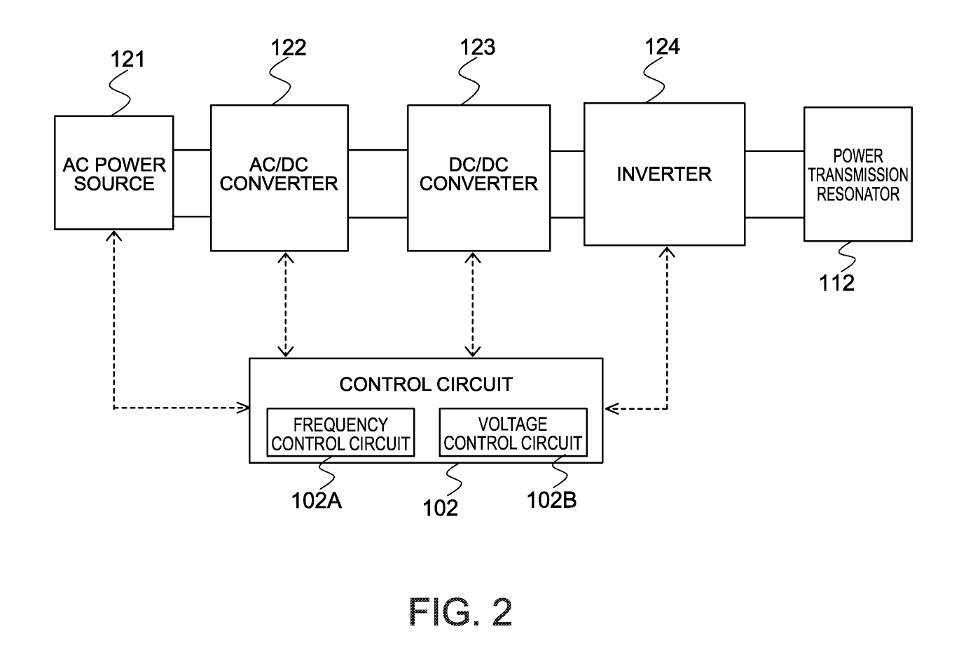

The high-frequency power source device 111 of the power transmitter 101 generates a high-frequency power that is AC power, and supplies the generated high-frequency power to the power transmission resonator 112. FIG. 2 shows an example of a power transmission device that is a specific implementation of the configuration of the high-frequency power source device 111.

In FIG. 2, the high-frequency power source device 111 includes an AC power source 121, an AC/DC converter 122, a DC/DC converter 123, and an inverter 124. These elements 121 to 124 are connected to the control circuit 102, and are controlled by the control circuit 102. Control signals or data signals transmitted and received between these elements 121 to 124 and the control circuit 102 are indicated by broken lines. Examples of the control signals include signals for instructing the respective elements on operations. Examples of the data signals include signals for notifying the operation states of the elements and the values of voltages and currents at predetermined sites to the control circuit 102. Signals other than those described here may be defined.

The AC power source 121 supplies AC power (AC voltage and alternating current) with a certain frequency. An example of the AC power source 121 is a commercial power source. The commercial power source is, for example, a device that outputs AC voltage having a frequency of 50 or 60 Hz and single-phase 100 V or three-phase 200 V.

The AC/DC converter 122 is a circuit that is connected to the AC power source 121 through wiring (a cable and the like), and converts the AC power supplied from the AC power source 121 into DC voltage.

The DC/DC converter 123 is a circuit that is connected to the AC/DC converter 122 through wiring, and converts (steps up or down) the DC voltage supplied from the AC/DC converter 122 into different DC voltage. The DC/DC converter 123 includes switching elements, such as semiconductor switches, and controls these switching elements to convert the voltage. The step-up ratio or step-down ratio (hereinafter described as the step-up/down ratio) of the switching element can be controlled by controlling the operation frequency or pulse width thereof. A configuration from which the DC/DC converter 123 is omitted can be adopted.

The inverter 124 is a circuit that is connected to the DC/DC converter 123 through wiring, and generates AC power (alternating current and AC voltage) on the basis of the DC voltage supplied from the DC/DC converter 123. Here, high-frequency power is generated as AC power. The inverter 124 supplies the generated AC power to the power transmission resonator 112. The inverter 124 generates AC power through pulse width modulation (PWM), for example. The pulse width modulation controls the pulse width to thereby control the output voltage. For example, the pulse is output every constant time, and increase in pulse width outputs a high voltage and decrease in pulse width outputs a low voltage.

The power transmission resonator 112 is connected to the inverter 124 through wiring. The power transmission resonator 112 is a resonant circuit that includes a coil (inductor) and a capacitor (capacitance). The power transmission resonator 112 causes the coil to generate magnetic fields in response to the high-frequency power (high-frequency current) received from the inverter 124, and couples the magnetic fields to the coil of the power reception resonator 211 of the power reception device, thereby performing wireless power transmission.

The configuration of the high-frequency power source device 111 is not necessarily limited to FIG. 2. For example, a circuit, such as a filter circuit, may be inserted between the DC/DC converter 123 and the inverter 124.

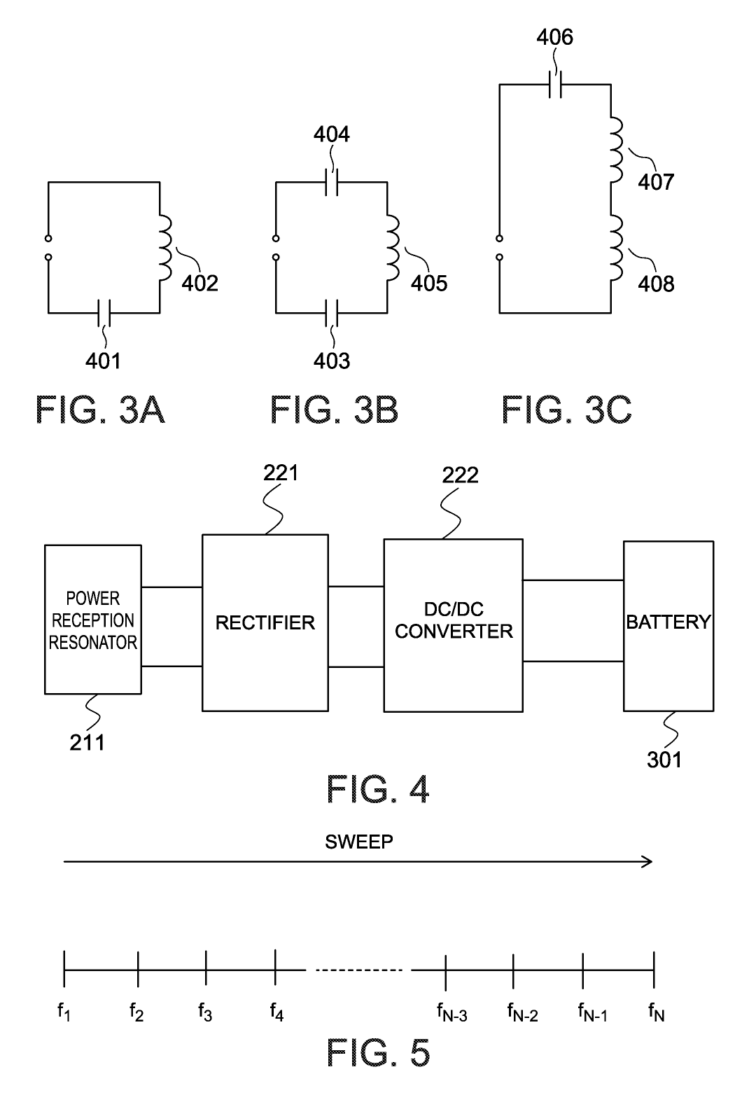

FIGS. 3A, 3B and 3C show configuration examples of the power transmission resonator 112. In the configuration in FIG. 3A, a capacitor 401 is connected in series to one end of a coil 402. The capacitor 401 may be connected to an opposite side to that in FIG. 3A, that is, the other end of the coil 402. As shown in FIG. 3B, capacitors 403 and 404 may be connected to the opposite sides of a coil 405. As shown in FIG. 3C, multiple coils 407 and 408 and a capacitor 406 may be connected in series. The coils 402, 405, 407 and 408 shown in FIGS. 3A to 3C may be wound around a magnetic core. The shape of coil may be formed by any winding manner, such as spiral winding, or solenoid winding. A configuration other than that in FIGS. 3A to 3C can be adopted.

The power receiver 201 of the power reception device 2 includes the power reception resonator 211, and the power reception circuit 212. The power reception resonator 211 wirelessly receives the AC power (high-frequency power) through coupling to the magnetic fields emitted from the power transmission resonator 112 of the power transmitter 101. The power reception resonator 211 is coupled to the power transmission resonator 112 with any coupling coefficient. The power reception resonator 211 supplies the received AC power to the power reception circuit 212. The power reception resonator 211 can be achieved with any of the configurations in FIGS. 3A and 3C in a manner analogous to that of the power transmission resonator 112. The power reception resonator 211 has the same resonant frequency as the power transmission resonator 112 does, or has a value close thereto. Accordingly, efficient wireless power transmission is achieved.

The power reception circuit 212 is connected to the power reception resonator 211 through wiring, converts the AC power received by the power reception resonator 211 into DC voltage suitable for the battery 301, and outputs this voltage.

FIG. 4 shows the power reception device that is a specific implementation of the configuration of the power reception circuit 212. The power reception circuit 212 includes a rectifier 221, and a DC/DC converter 222.

The rectifier 221 is connected to the power reception resonator 211 through wiring, and converts the reception power (AC power) received from the power reception resonator 211 into DC voltage. That is, the rectifier 221 is an AC/DC converter circuit that converts alternating current into direct current. The rectifier 221 may have any configuration. For example, the rectifier 221 may be made up of a diode bridge.

The DC/DC converter 222 is connected to the rectifier 221 through wiring, converts the DC voltage output from the rectifier 221 into an available voltage (a voltage higher than, identical to, or lower than the constant DC voltage) for the battery 301, and outputs this voltage. The DC/DC converter 222 includes switching elements, such as semiconductor switches, and controls the operations of these switching elements to convert the voltage. The step-up ratio or step-down ratio (hereinafter described as the step-up/down ratio) of the switching element can be controlled by controlling the operation frequency thereof.

The battery 301 is a device that accumulates the power input from the DC/DC converter 222 of the power reception circuit 212. Instead of the battery 301, a resistor (motor or the like) that consumes power may be adopted. The resistor and the battery are collectively called a load device.

The control circuit 102 of the power transmission device 1 controls the high-frequency power source device 111. In the case where the high-frequency power source device 111 has the configuration in FIG. 2, the control circuit 102 controls the AC power source 121, the AC/DC converter 122, the DC/DC converter 123, and the inverter 124. In the following description, it is assumed that the high-frequency power source device 111 has the configuration in FIG. 2. Furthermore, it is assumed that the power reception circuit 212 has the configuration in FIG. 4.

A frequency control circuit 102A sweeps (modulates) the frequency of the AC power output from the high-frequency power source device 111 (that is, the frequency of the output current of the inverter 124) in a predetermined frequency range. More specifically, the frequency is swept (frequency-modulated) from a start frequency to an end frequency. The change in frequency is performed by controlling the drive timings of multiple switching elements included in the inverter, for example. The start frequency and the end frequency may be freely defined. For example, the start frequency is the lowest frequency of the frequency range. The end frequency is the highest frequency of the frequency range. Alternatively, the start frequency may be the highest frequency of the frequency range. The end frequency may be the lowest frequency of the frequency range. The start frequency and the end frequency may be defined in the frequency range by another method. The frequency sweep speed and sweep unit width (the frequency change width for one time) may be predefined.

FIG. 5 shows an example of frequency sweeping. The frequency sweeping is performed from the start frequency “f₁” to the end frequency “f_{N}”. The frequencies “f₁”, “f₂”, “f₃”, . . . , “f_{N-2}”, “f _{N-1}”, “f_{N}” are arranged at constant widths. At “f1”, power transmission is started. After lapse of a certain time period, it is moved to the next frequency “f₂”, and power transmission is performed at “f₂”. After lapse of the certain time period, it is moved to the next frequency “f₃”, and power transmission is performed at “f₃”. An analogous operation is repeated until “f_{N}”. After power transmission at “f_{N}” is completed, the frequency is returned to the frequency “f₁”. The sweep described here is only an example. The technique is not limited to this example. For example, the frequency change width for one time may be defined to be small, thereby allowing more smooth movement to be achieved from “f₁” to “f_{N}”. Alternatively, frequency sweeping is performed in a frequency skipping manner such that “f_{N-2}”→“f₃”→“f_{N-1}”→“f₂”, . . . .

A voltage control circuit 102B of the control circuit 102 controls the output voltage of the inverter 124 on the basis of the ratio between the voltage (the input voltage of the rectifier 221) of the power received by the power reception circuit 212 and the voltage (the output voltage of the inverter 124) of the AC power output from the high-frequency power source device 111 of the power transmission device 1. This ratio (hereinafter, simply called a voltage ratio in some cases) may be calculated according to the rectifier input voltage/inverter output voltage, or according to the inverter output voltage/rectifier input voltage. In the following description, the former is assumed. “/” means division. The voltage control circuit 102B controls the output voltage of the inverter 124 so that the voltage ratio can satisfy the target condition of the voltage value.

An example of the target condition includes approach to the target value (predetermined value) or accommodation in the target range (predetermined range). Note that the target condition is not limited to the examples. For example, the condition may be that the ratio of time in which the voltage ratio resides in the target range is equal to or higher than a threshold. In the following description, the example of approach to the target value (predetermined value) or accommodation in the target range (predetermined range) is exemplified and the description is made.

The voltage control circuit 102B may determines the target condition (e.g., the predetermined value or the predetermined range) on the basis of the frequency sweep range.

Such control of the voltage ratio based on the target condition can prevent the ripple voltage from occurring on the power reception side even with frequency sweeping. The details are described later.

The voltage control circuit 102B obtains the voltage or current or both thereof (hereinafter voltage/current) at one or more sites in the high-frequency power source device 111, and predicts the input voltage of the rectifier 221 on the basis of the obtained voltage/current. The high-frequency power source device 111 includes a detection circuit that detects the voltage or current or both thereof at the predetermined site. The voltage control circuit 102B calculates the voltage ratio using the predicted input voltage. To achieve the calculation, the relationship between the voltage/current at one or more sites in the high-frequency power source device 111 and the input voltage of the rectifier 221 is preliminarily grasped through a circuit simulation or an inspection at shipment. Data that represents the relationship is obtained through a table or a calculation expression. The input voltage of the rectifier 221 is predicted on the basis of this data and the output voltage of the inverter 124.

The site at which the voltage/current is detected to predict the input voltage of the rectifier 221 may be any site only if the site has a dependent relationship with the input voltage of the rectifier 221. For example, the site may be for the output voltage of the AC/DC converter 122, the input voltage of the DC/DC converter 123, the input voltage of the inverter 124, or the output voltage of the DC/DC converter 123. The site may be for the voltage or current at a terminal of any element in the AC/DC converter 122, the DC/DC converter 123, or the inverter 124.

Here, the fact that appropriate control of the voltage ratio to satisfy the target condition can prevent the ripple voltage on the power reception side from occurring even with frequency sweeping, is described in detail.

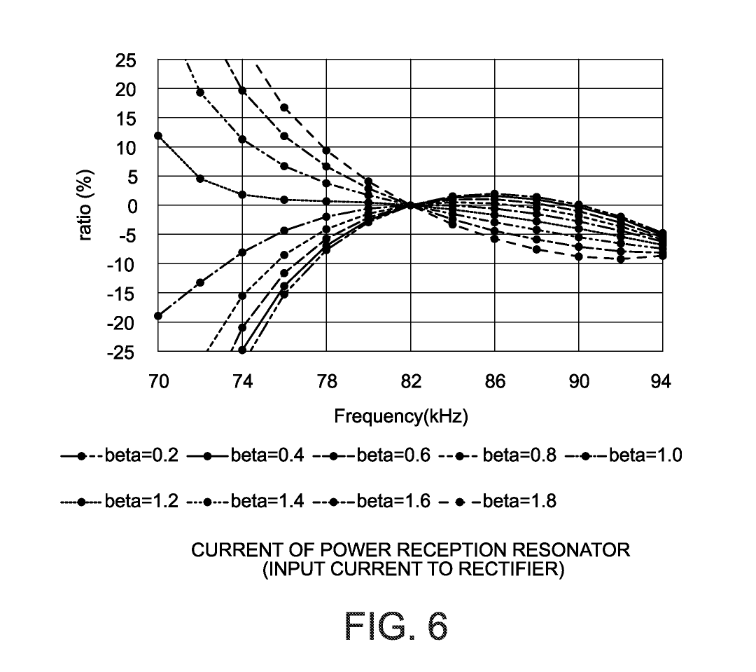

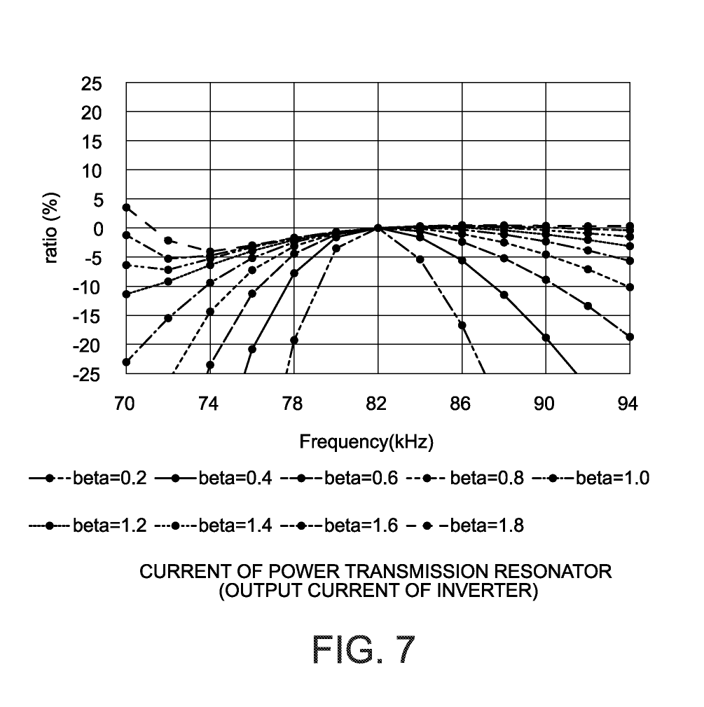

FIGS. 6 and 7 show simulation results by the present inventors. FIGS. 6 and 7 are the results of simulation performed under a predetermined setting condition; the former is on variation in input current (the current of the power reception resonator) of the rectifier 221, and the latter is on variation in output current (the current of the power transmission resonator) of the inverter 124. SPICE (Simulation Program with Integrated Circuit Emphasis) is used for the simulation.

The setting condition of the simulation is that the resonant frequency of the power transmission resonator and the power reception resonator is 82 kHz, and the power transmission frequency is changed in a range of 70 to 94 kHz. The center frequency of the range to be changed is 82 kHz, which coincides with the resonant frequency.

In this case, a value (variation ratio) is calculated by normalizing the amount of variation in the current of the power reception resonator due to the frequency deviation (the width of change in frequency from the center frequency) with respect to the current of the power reception resonator at the center frequency. FIG. 6 shows the result. A value is calculated by normalizing the amount of variation in the current of the power transmission resonator due to the frequency deviation with respect to the current of the power transmission resonator at the center frequency. FIG. 7 shows the result. In FIGS. 6 and 7, the abscissa axis indicates the frequency, and the ordinate axis indicates the variation ratio.

In the simulation, “β” is set in eight cases that are 0.2, 0.4, 0.6, 0.8, 1.0, 1.2, 1.4, 1.6, and 1.8 “β” represents the voltage ratio, that is, the ratio between the input voltage of the rectifier 221 and the output voltage of the inverter 124 (rectifier input voltage/inverter output voltage). For example, the output voltage of the inverter 124 is the effective value of the output voltage. The input voltage of the rectifier 221 is the effective value of the input voltage. During the simulation, the frequency sweeping is performed in the range of 70 to 94 kHz described above.

Here, a case of frequency sweeping in any bandwidth freely selected from the range of 70 to 94 kHz is discussed. For example, provided that sweeping is performed in a width of 6 kHz, the variation ratio of the power reception resonator becomes low at “β”=1.2 with reference to FIG. 6. The variation ratio of the power transmission resonator becomes low at β=1.8. As a value at which the variation ratios are commonly low in both the cases, “β”=1.2 is selected, for example. If the range of the sweep frequency is in 78 to 94 kHz or selected from this range, the variation in current can be further suppressed. In the case where the sweep range is 78 to 94 kHz, the center frequency (91 kHz) of this range is higher than the resonant frequency 82 kHz of the power transmission resonator and the power reception resonator.

For example, it may be configured such that the frequency sweeping of the frequency control circuit 102A is performed after adjustment of output voltage of the inverter 124 by the voltage control circuit 102B is completed but the voltage adjustment is not performed during one time of sweeping in the sweep range (sweeping for one period). At the middle of sweeping, negation of voltage adjustment, which is to follow the frequency sweeping, can simplify the configuration. In this case, after one-time sweeping in the sweep range is finished and the frequency is returned to the start frequency, the inverter output voltage is readjusted. Even during sweeping in the sweep range, the voltage adjustment may be appropriately performed. For example, the voltage adjustment may be performed every time a frequency width “Δf”, which is shorter than the sweep range, is swept. Accordingly, although the voltage adjustment that follows the frequency sweeping is required, the voltage adjustment in this embodiment is a simple adjustment that makes the voltage ratio approach the predetermined value or accommodates the voltage ratio in the predetermined range. Consequently, a large load does not occur.

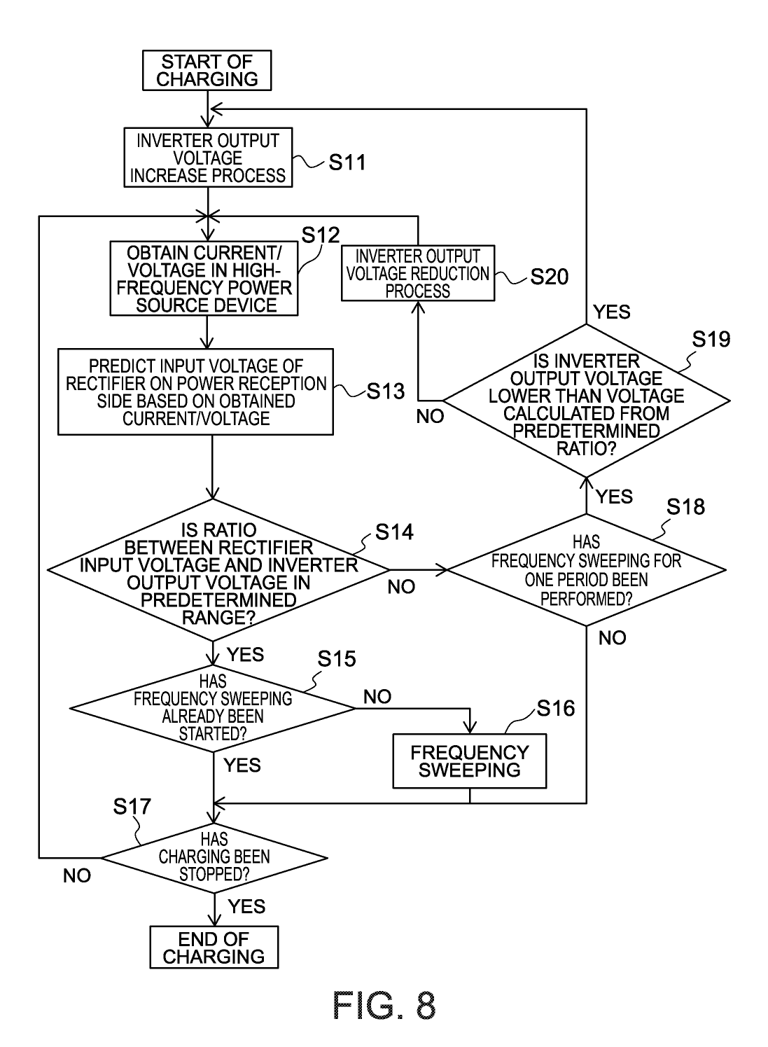

FIG. 8 is a flowchart of operations of the control circuit 102 according to this embodiment.

In step S11, upon receipt of a charge control instruction from an external device, the voltage control circuit 102B of the control circuit 102 performs a start-up operation so as to increase the output voltage of the inverter 124 to the target voltage. The external device may be an input interface for a user (touch panel or the like), the control device of the wireless power transfer system, or another device. The power transmission frequency in the start-up operation may be the resonant frequency of the power transmission resonator or the power reception resonator, a frequency close thereto, or any frequency in the sweep frequency range. Instead of the target voltage, a target current may be used to increase the output current of the inverter 124 to the target current.

In step S12, when the output voltage of the inverter 124 reaches the target voltage, power transmission is started, and the voltage control circuit 102B obtains the voltage or current at one or more predetermined sites in the high-frequency power source device 111 or both thereof (hereinafter voltage/current).

In step S13, the voltage control circuit 102B predicts the input voltage of the rectifier 221 on the power reception side, on the basis of the obtained voltage/current, using the preliminarily obtained data, such as the relational expression or table.

In step S14, the voltage control circuit 102B determines whether or not the voltage ratio between the input voltage of the rectifier 221 and the output voltage of the inverter 124 is in the predetermined range, that is, satisfies the target condition.

Provided that the predetermined value (hereinafter described as the predetermined ratio in some cases) is 1.2, the predetermined range is from 1.15 to 1.25, inclusive. Preferably, the predetermined value has a value with a small amount of variation of at least one of the current of the power reception resonator and the current of the power transmission resonator, even when the frequency is swept in the sweep range. The voltage control circuit 102B may determine the predetermined value or the predetermined range on the basis of the frequency sweep range (see the description with reference to FIGS. 6 and 7). For example, the voltage ratio having the minimum width of change in the variation ratio within the sweep range may be adopted as the predetermined value. Alternatively, a range having a certain width centered at the voltage ratio may be adopted as the predetermined range. The determination may be made by a method other than the methods described here.

If the voltage ratio is in the predetermined range (YES in S14), determination is made as to whether the frequency sweeping has already been started or not in step S15. In step S15 at the first time after start of the flowchart, the frequency sweeping has not been started yet (NO in S15). Accordingly, the processing proceeds to step S16, and the frequency control circuit 102A starts the frequency sweeping. Subsequently, the processing proceeds to step S17.

In step S17, determination is made as to whether the charge end condition is satisfied or not. Examples of the end condition include a case where a certain time period has elapsed after the start of transmission, a case where the charging of the battery 301 is completed, and a case where the end condition is received from the user of the battery via the input interface. If the end condition is satisfied (YES), this processing is finished. If the end condition is not satisfied (NO), the processing returns to step S12.

If it is determined that the voltage ratio is not in the predetermined range in step S14, determination is made as to whether sweeping for one period is completed or not in step S18. That is, determination is made as to whether the sweeping from the start frequency to the end frequency of the sweep range is completed and the frequency is returned to the start frequency for the next period. If the sweeping for one period has not been completed (NO), the processing proceeds to step S17. If the end condition is not satisfied (NO) in step S17, the processing returns to step S12.

If it is determined that the sweeping for one period is finished in step S18, determination is made as to whether the output voltage of the currently measured inverter 124 is lower than the inverter output voltage calculated on the basis of the predetermined ratio (e.g., 1.2) in step S19 or not. For example, provided that the current input voltage of the rectifier is “V₁” and the predetermined ratio is “H”, the inverter output voltage calculated from the predetermined ratio “H” is “V₁/H”. Provided that the currently measured output voltage of the inverter 124 is “V₂”, determination is made as to whether “V₂” is lower than “V₁/H”.

If the currently measured output voltage of the inverter 124 is lower than the inverter output voltage calculated from the predetermined ratio (YES in step S19), the output voltage of the inverter 124 is increased in step S11. For example, the output voltage is increased by the difference between the current output voltage and the calculated output voltage. Consequently, the voltage ratio can be caused to approach the predetermined value, or accommodated in the predetermined range. Instead of the increase in the output voltage by the difference, increase in the output voltage of the inverter 124 by a predetermined increase width “Δα₁” may be adopted.

On the contrary, if the currently measured output voltage of the inverter 124 is equal to or higher than the inverter output voltage calculated from the predetermined ratio (NO in step S19), the output voltage of the inverter 124 is reduced in step S20. For example, the output voltage is reduced by the difference between the current output voltage and the calculated output voltage. Consequently, the voltage ratio can be caused to approach the predetermined value, or accommodated in the predetermined range. Instead of the reduction in the output voltage by the difference, reduction in the output voltage of the inverter 124 by a predetermined reduction width “Δγ₁” may be adopted, for example.

After step S11 or S20, if it is determined that the voltage ratio is not in the predetermined range in step S14 (NO in S14), it is determined NO in step S18. Consequently, the sweeping this time is continued to the end frequency, with the voltage ratio being not determined to be in the predetermined range. If the voltage ratio is not in the predetermined range when the sweeping for this period is completed, the rectifier input voltage is increased or reduced (S11 or S20).

In the operations of this flowchart, the output voltage of the inverter 124 is adjusted when the frequency returns to the start frequency. Alternatively, the output voltage of the inverter 124 may be adjusted during power transmission at the end frequency. As described above, the output voltage of the inverter 124 may be adjusted one or multiple times in the middle of sweeping. If the voltage ratio is not determined to be in the predetermined range according to the determination in step S14, the voltage may be adjusted at the time point (without waiting for the completion of the current period).

In the operations of this flowchart, the frequency sweeping is started after the voltage ratio is accommodated in the predetermined range at the time of starting power transmission. Subsequently, frequency sweeping is started. After the start of sweeping, the adjustment of the output voltage of the inverter 124 is not required, unless the voltage ratio is not out of the predetermined range. Consequently, the process load is largely reduced.

As described above, the frequency sweeping is performed while the voltage ratio is controlled to be the target value (predetermined value) or be in the target range (predetermined range), thereby allowing the variation in the received current on the power reception side (occurrence of ripples) to be suppressed while reducing the radiation magnetic field intensity. Consequently, application of a large load to the electric circuit on the power reception side can be prevented, and reduction in battery life can be suppressed. The predetermined value or the predetermined range is selected so as to suppress the variation in current not only on the power reception side but also on the power transmission side, thereby allowing the load to the circuit on the power transmission side to be reduced.

According to this operation, on the power transmission side, the input voltage of the rectifier is predicted on the basis of the voltage/current at the predetermined site in the high-frequency power source device. That is, the relationship between the voltage/current at the predetermined site and the input voltage of the rectifier is preliminarily obtained, and the voltage on the power reception side is predicted using the data on the relationship. Consequently, the state of the power reception device is not required to be fed back to the power transmission device, and the configuration is simple.

### Second embodiment

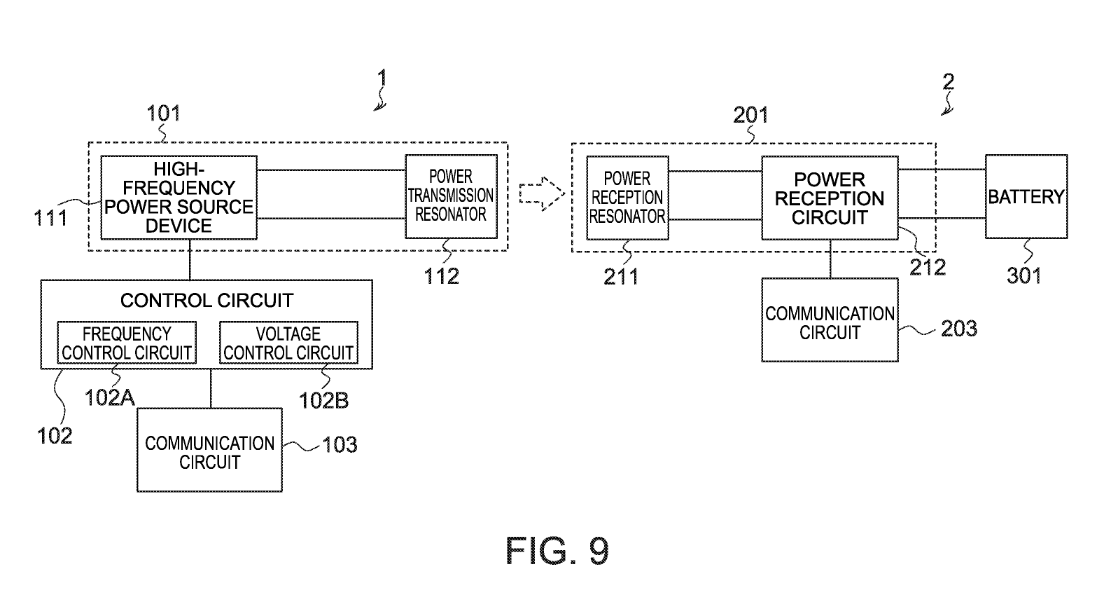

FIG. 9 is a diagram showing a wireless power transfer system according to a second embodiment. The elements identical or corresponding to those in FIG. 1 are assigned the same symbols. The description thereof is appropriately omitted. The system in FIG. 1 is provided additionally with a communication circuit 103 on the power transmission side, and a communication circuit 203 on the power reception side. The communication circuit 103 on the power transmission side is connected to the control circuit 102. A communication circuit 203 on the power reception side is connected to the power reception circuit 212. The communication circuits 103 and 203 communicate with each other according to predetermined procedures.

The communication may be wireless communication or wired communication. In the case of the wireless communication, the communication circuits 103 and 203 are each mounted with one or more antennas.

In the first embodiment, the voltage control circuit 102B on the power transmission side predicts the input voltage (the input voltage of the power reception circuit 212) of the rectifier 221 on the power reception side on the basis of the voltage/current at a predetermined site in the high-frequency power source device 111. In this embodiment, the input voltage of the rectifier 221 is not predicted. Instead, the voltage control circuit 102B obtains information that represents the input voltage of the rectifier 221 from the communication circuit 203 on the power reception side. More specifically, the communication circuit 103 receives the information from the communication circuit 203, and passes the information to the voltage control circuit 102B of the control circuit 102.

The power reception circuit 212 or the rectifier 221 includes a detection circuit that detects the input voltage. The detection circuit notifies the information that represents the detected input voltage to the communication circuit 203. The communication circuit 203 transmits the information to the power transmission device 1. The detection circuit may detect the input voltage at predetermined intervals, or detect the input voltage at a timing when a measurement instruction is received from the power transmission device. In the latter case, the voltage control circuit 102B transmits the measurement instruction for the input voltage via the communication circuit 103. The communication circuit 203 receives a measurement instruction, and notifies this instruction to the power reception circuit 212 or the rectifier 221.

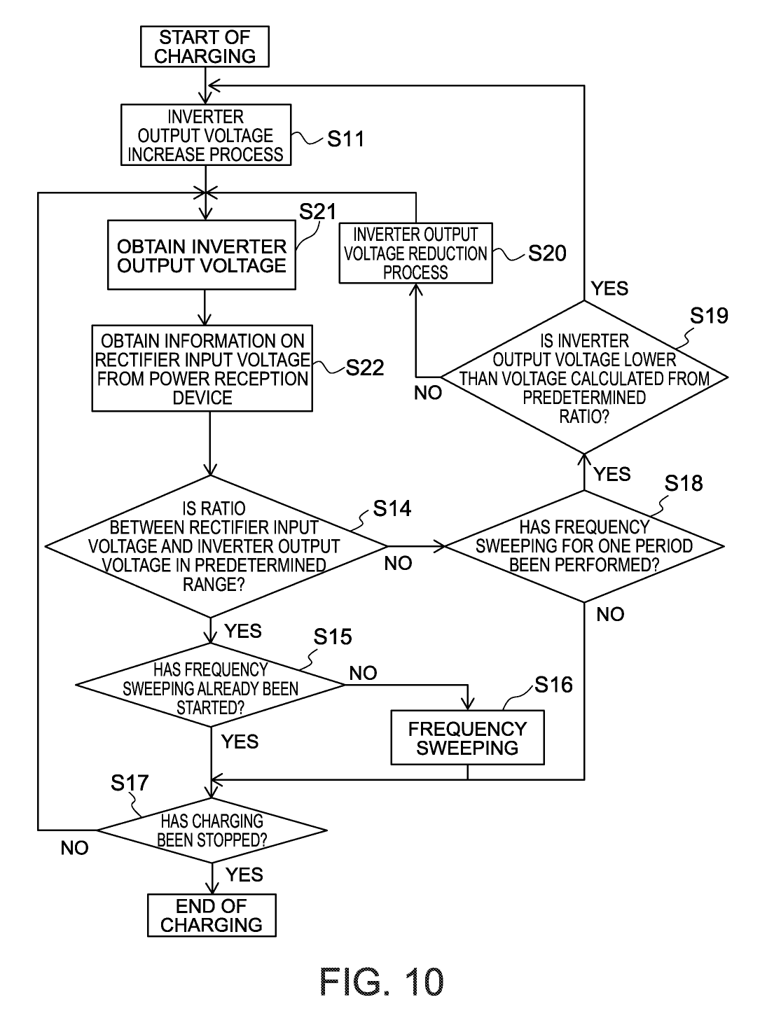

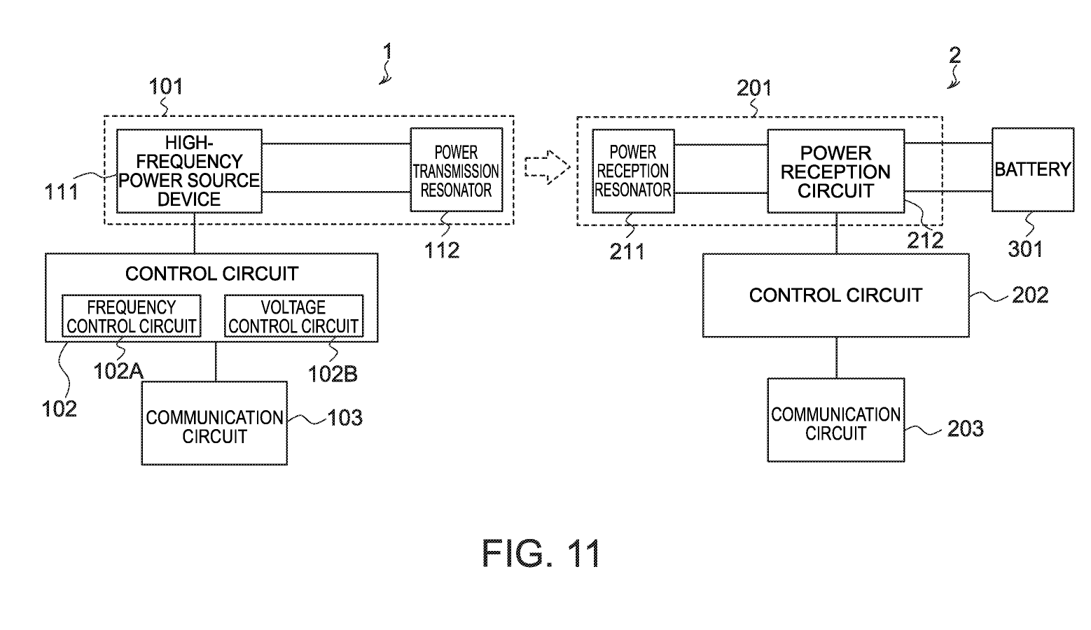

FIG. 10 is a flowchart of operations of the control circuit 102 according to this embodiment. steps S12 and S13 in FIG. 7 are changed to steps S21 and S22, respectively. In step S21, the output voltage of the inverter is obtained. In step S22, information that represents the input voltage (the input voltage of the power reception circuit 212) of the rectifier 221 on the power reception side is obtained from the power reception device through communication. As with the first embodiment, in step S14, determination is made as to whether the ratio between the input voltage of the rectifier 221 and the output voltage of the inverter 124 is in the predetermined range or not. The processes thereafter are analogous to those in the first embodiment.

In this embodiment, the control circuit 102 of the power transmission device is not required to predict the input voltage of the rectifier 221. Consequently, the configuration of the control circuit 102 of the power transmission device can be simplified.

### Third embodiment

FIG. 11 is a diagram showing a wireless power transfer system according to a third embodiment. The elements identical or corresponding to those in FIG. 9 are assigned the same symbols. The description thereof is appropriately omitted.

In the first and second embodiments, the output voltage of the inverter 124 is controlled so that the ratio (hereinafter the voltage ratio) between the input voltage of the rectifier 221 and the output voltage of the inverter 124 can approach the target value (the predetermined value) or can be accommodated in the target range (predetermined range). In this embodiment, the output voltage of the inverter 124 is not controlled, but the input voltage of the rectifier 221 is controlled instead, which characterizes this embodiment.

The power reception device 2 includes a control circuit 202 that serves as a second control circuit. The control circuit 202 controls the input voltage of the rectifier 221 so that the voltage ratio can satisfy the target condition, more specifically, the voltage ratio can approach the predetermined value or can be accommodated in the predetermined range. As with the voltage control circuit 102B in the first embodiment, the voltage control circuit 202 may determine the predetermined value or the predetermined range on the basis of the frequency sweep range.

The voltage control circuit 102B of the control circuit (first control circuit) 102 on the power transmission side obtains information that represents the output voltage of the inverter 124 from the high-frequency power source device 111, and transmits the obtained information through the communication circuit 103. The communication circuit 203 on the power reception side receives the information, and passes the received information to the control circuit 202. Accordingly, the control circuit 202 grasps the output voltage of the inverter 124.

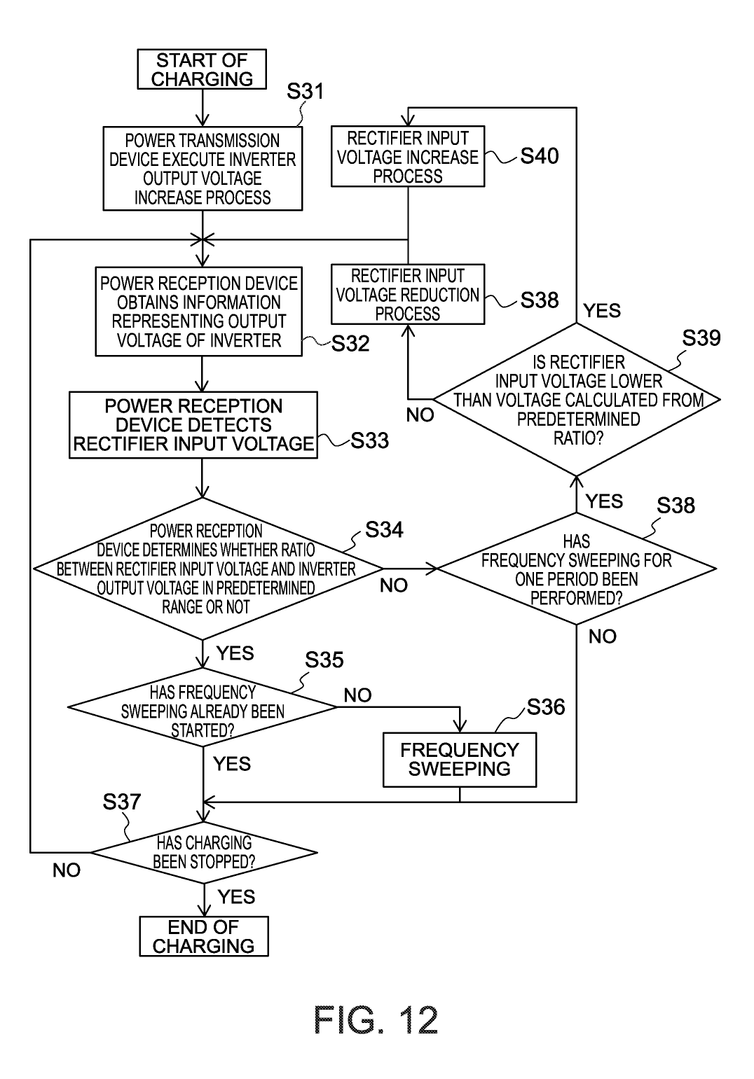

FIG. 12 is a flowchart of operations of the wireless power transfer system according to this embodiment.

In step S31, upon receipt of a charge control instruction from an external device, the voltage control circuit 102B of the power transmission device 1 performs a start-up operation so as to increase the output voltage (transmission voltage) of the inverter 124 to the target voltage.

In step S32, the control circuit 202 of the power reception device 2 obtains the information that represents the output voltage of the inverter 124 from the power transmission device 1.

In step S33, the control circuit 202 of the power reception device 2 obtains the information that represents the input voltage of the rectifier 221 from the power reception circuit 212.

In step S34, the control circuit 202 of the power reception device 2 determines whether or not the voltage ratio (the ratio between the input voltage of the rectifier 221 and the output voltage of the inverter 124) is in the predetermined range.

If it is determined that the ratio is in the predetermined range (YES in step S34), the control circuit 202 of the power reception device 2 determines whether the frequency sweeping has already been started or not in step S35. Since the sweeping has not been started yet (NO in S35), the processing proceeds to step S36, and the control circuit 202 of the power reception device 2 transmits a notification that indicates the completion of the voltage adjustment to the power transmission device 1 via the communication circuit 203. The control circuit 102 of the power transmission device 1 having received the notification starts frequency sweeping. Subsequently, the processing proceeds to step S37.

In step S37, determination is made as to whether the charge end condition is satisfied or not. Examples of the end condition include a case where the control circuit 202 of the power reception device 2 receives a power transmission end condition from the power transmission device, and a case where the end condition is received from the user of the battery through the input interface (touch panel or the like). If the end condition is satisfied (YES in step S37), this processing is finished. If the end condition is not satisfied (NO in step S37), the processing returns to step S32.

In step S34, if the control circuit 202 of the power reception device 2 determines that the voltage ratio is in the predetermined range (NO in step S34), determination is made as to whether or not sweeping for one period has been finished (i.e., the frequency has been returned to the start frequency) in step S38. For example, the completion of sweeping for one period is determined according to whether or not information on completion of sweeping for one period is received from the power transmission device, or whether or not a certain time period has elapsed from the start of sweeping. In a case where the order of sweep frequencies is preliminarily grasped, the change in frequency may be monitored, and it may be determined that the sweeping for one period is finished when power transmission at the end frequency is performed or the frequency is returned to the start frequency. The determination may be made by a method other than the methods described here. If it is determined that the sweeping for one period has not been finished (NO in step S38) the processing proceeds to step S37. If it is determined that the sweeping for one period has been finished (YES in step S38), the processing proceeds to step S39. If the sweeping has never been started after start of the processes of this flowchart, the processing proceeds to step S39.

In step S39, determination is made as to whether the currently measured input voltage of the rectifier 221 is lower than the rectifier input voltage calculated from the predetermined value (predetermined ratio). For example, provided that the output voltage of the inverter 124 is “V₂” and the predetermined ratio is “H”, the rectifier input voltage calculated from the predetermined ratio “H” is “V₂×H”. Provided that the currently measured input voltage of the rectifier 221 is “V₁”, determination is made as to whether “V₁” is lower than “V₂×H” or not.

If the currently measured input voltage of the rectifier 221 is lower than the rectifier input voltage calculated from the predetermined ratio (YES in step S39), the control circuit 202 increases the input voltage of the rectifier 221 in step S40. For example, the input voltage is increased by the difference between the current input voltage and the calculated input voltage. Consequently, the voltage ratio can be caused to approach the predetermined value, or accommodated in the predetermined range. Alternatively, the input voltage of the rectifier 221 may be increased by a predetermined increase width “Δα₂”.

On the contrary, if the currently measured input voltage of the rectifier 221 is equal to or higher than the rectifier input voltage calculated from the predetermined ratio (NO in step S41), the control circuit 202 of the power reception device 2 reduces the input voltage of the rectifier 221. For example, the input voltage is reduced by the difference between the current input voltage and the calculated input voltage. Consequently, the voltage ratio can be caused to approach the predetermined value, or accommodated in the predetermined range. Alternatively, the input voltage of the rectifier 221 may be reduced by a predetermined increase width “Δγ₂”.

Increase or reduction in the input voltage of the rectifier 221 may be performed by changing the step-up/down ratio of the DC/DC converter 222 or by changing the impedance of the power reception circuit 212, for example. A predetermined circuit may be arranged between the rectifier 221 and the power reception resonator 211 to adjust the impedance of the predetermined circuit.

After steps S32 and S33, if it is determined that the voltage ratio is not in the predetermined range in step S34 (NO in S34), the determination is NO in step S38, and the sweeping for this period is continuously performed to the end frequency, with the voltage ratio being determined to be not in the predetermined range. If the voltage ratio is not in the predetermined range when the sweeping for this period is completed, the rectifier input voltage is increased or reduced (S40 or S38).

According to the operations of this flowchart, after start-up of the output voltage of the inverter 124 in step S31, the frequency sweeping is started when the voltage ratio becomes in the predetermined range. Alternatively, the frequency sweeping can be started at the time of start-up of the output voltage of the inverter 124. In this case, steps S35 and S36 are not required.

According to the operations of this flowchart, the input voltage of the rectifier 221 is adjusted every time of sweeping for one period. As with the first and second embodiments, the input voltage may be adjusted every time the sweep range is changed by a certain frequency width “Δf”. Alternatively, the input voltage may be adjusted at another freely selected timing. If the voltage ratio is not determined to be in the predetermined range according to the determination in step S34, the voltage may be adjusted at the time point (without waiting for the completion of the current period).

In this embodiment, the output voltage of the inverter 124 is grasped by receiving the information that represents the output voltage of the inverter 124 from the power transmission device 1. Alternatively, as with the first embodiment, the output voltage of the inverter 124 may be estimated from the voltage/current at one or more predetermined sites in the power reception circuit 212. In this case, data in which the voltage/current at one or more predetermined sites in the power reception circuit 212 and the output voltage of the inverter 124 are associated with each other may be prepared, and the estimation is performed using this data.

According to this embodiment, the voltage ratio is adjusted to the predetermined value or in the predetermined range on the power reception device side, thereby allowing the variation in received current on the power reception side to be suppressed even with frequency sweeping on the power transmission side.

### Fourth embodiment

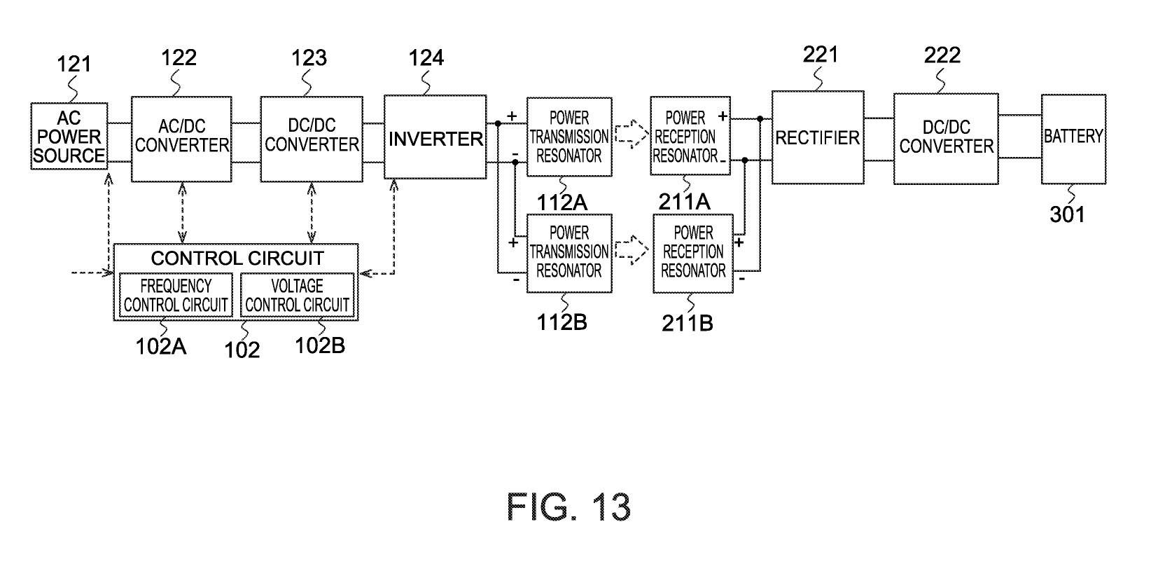

FIG. 13 is a diagram showing a wireless power transfer system according to a fourth embodiment. The elements identical or corresponding to those in FIGS. 2 and 4 are assigned the same symbols. The description thereof is appropriately omitted.

In the first embodiment, the number of power transmission resonators and the number of power reception resonators are each one. In this embodiment, a case where the numbers are each two is described. That is, wireless power transmission is performed through two systems.

The power transmission resonator 112A and the power transmission resonator 112B are each connected to output terminals (a positive terminal and a negative terminal) of the inverter 124. Note that the connection polarities are inverted from each other. That is, the positive terminal of the power transmission resonator 112A is connected to the positive terminal of the inverter 124, while the negative terminal of the power transmission resonator 112A is connected to the negative terminal of the inverter 124. Meanwhile, the positive terminal of the power transmission resonator 112B is connected to the negative terminal of the inverter 124, while the negative terminal of the power transmission resonator 112B is connected to the positive terminal of the inverter 124. Accordingly, currents output from the inverter 124 are input into the power transmission resonator 112A and the power transmission resonator 112B as currents (opposite phase currents) having phases deviating from each other by 180 degrees or approximately 180 degrees. Such opposite-phase configuration allows the magnetic fields emitted from the power transmission resonator 112A and the power transmission resonator 112B to cancel each other at remote positions, thereby reducing the leaking magnetic field. The phase difference is not necessarily 180 degrees to exert the magnetic field canceling effect. For example, a desired extent of reduction effect may be achieved by providing a range between plus and minus “a” for 180 degrees.

The magnetic fields generated by the power transmission resonator 112A and the power transmission resonator 112B are coupled to power reception resonators 211A and 211B, respectively. The power reception resonator 211A and the power reception resonator 211B are connected to the input terminals (positive and negative terminals) of the rectifier 221. Note that the connection polarities are inverted from each other. That is, the positive terminal of the power reception resonator 211A is connected to the positive terminal of the rectifier 221, while the negative terminal of the power reception resonator 211A is connected to the negative terminal of the rectifier 221. Meanwhile, the positive terminal of the power reception resonator 211B is connected to the negative terminal of the rectifier 221, while the negative terminal of the power reception resonator 211B is connected to the pulse terminal of the rectifier 221. Accordingly, currents having the same phase are output from the power reception resonator 211A and the power reception resonator 211B. Thereby total power corresponding to the total of the currents is supplied to the rectifier 221.

In this embodiment, the wireless power transmission is performed through the two systems. Alternatively, the transfer may be performed through three or more systems. In this case, provided that the number of systems is “N”, the phases of the output currents of the inverter 124 may be controlled so that the phases deviating by 360 “degrees/N” or approximately 360 “degrees/N” can be input into respective “N” power transmission resonators.

The other configuration is the same as that in the first embodiment. The voltage control circuit 102B of the control circuit 102 may control the output voltage of the inverter 124 so that the ratio between the input voltage of the rectifier 221 and the output voltage of the inverter 124 can approach the predetermined value or be accommodated in the predetermined range. The mode where the number of systems is two or more as with this embodiment is applicable also to the second and third embodiments in an analogous manner.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A power transmission device comprising:
a power transmitter configured to transmit AC power by causing a coil to generate a magnetic field in response to AC power and coupling the magnetic field to a coil of a power receiver;
a frequency control circuit configured to sweep a frequency of the AC power during the power transmission; and
a voltage control circuit configured to control a voltage of the AC power, based on a target condition of a ratio between a voltage of power received by the power receiver and a voltage of the AC power.

2. The power transmission device according to claim 1,
wherein the voltage control circuit is configured to control the voltage of the AC power so as to allow the ratio as the target condition to approach a target value or be accommodated in a target range.

3. The power transmission device according to claim 2,
wherein the voltage control circuit is configured to adjust the voltage of the AC power so as to satisfy the target condition before start of sweeping of the frequency, and
the frequency control circuit is configured to sweep the frequency after the voltage of the AC power is adjusted.

4. The power transmission device according to claim 2,
wherein the voltage control circuit is configured to determine the target condition, based on a sweep range of the frequency.

5. The power transmission device according to claim 1,
wherein the power transmitter comprises a power transmission resonator that includes a coil, and
a center frequency of a sweep range of the frequency is higher than a resonant frequency of the power transmission resonator or a resonant frequency of a power reception resonator that includes the coil of the power receiver.

6. The power transmission device according to claim 1,
wherein the voltage control circuit is configured to obtain at least one of a voltage and a current at a predetermined site in the power transmitter, and predict the voltage received by the power receiver based on data that defines a relationship between at least one of the voltage and the current at the predetermined site and the voltage received by the power receiver.

7. The power transmission device according to claim 1,
wherein the voltage control circuit obtains information that represents the voltage received by the power receiver through communication, and grasps the voltage received by the power receiver based on the obtained information.

8. The power transmission device according to claim 1,
wherein the power transmitter comprises an inverter configured to generate the AC power from a DC input voltage, and
the voltage control circuit adjusts the voltage of the AC power by adjusting the input voltage of the inverter.

9. The power transmission device according to claim 1,
wherein the power transmitter comprises an inverter configured to generate the AC power from a DC input voltage, and an output of the inverter has a waveform of pulses, and
the voltage control circuit adjusts the voltage of the AC power by adjusting the width of the pulse.

10. The power transmission device according to claim 1,
wherein the power transmitter causes a plurality of the coils to generate a plurality of magnetic fields having different phases in response to the AC power, and the plurality of magnetic fields are coupled to the respective coils in the power receiver, and
the voltage of the power received by the power receiver is a voltage of a total power received by the plurality of coils in the power receiver.

11. A power reception device, comprising:
a power receiver configured to receive AC power by sweeping a frequency of the AC power, and causing a coil to be coupled to a magnetic field of a power transmission device configured to generate a magnetic field in response to the AC power; and
a control circuit configured to control a voltage of the reception power, based on a target condition of a ratio between the voltage of the reception power and the voltage of the AC power.

12. The power reception device according to claim 11,
wherein the control circuit is configured to control the voltage of the reception power so as to allow the ratio as the target condition to approach a target value or be accommodated in a target range.

13. The power reception device according to claim 12,
wherein the control circuit is configured to adjust the voltage of the reception power so as to allow the ratio to satisfy the target condition before start of sweeping the frequency, and sweeping of the frequency is started after the voltage is adjusted.

14. The power reception device according to claim 11,
wherein the voltage control circuit is configured to determine the target condition, based on a sweep range of the frequency.

15. The power reception device according to claim 11,
wherein the power receiver comprises a power reception resonator that includes a coil, and
a center frequency of a sweep range of the frequency is higher than a resonant frequency of the power reception resonator or a resonant frequency of a power transmission resonator that includes the coil that is included in the power transmission device and generates the magnetic field.

16. The power reception device according to claim 11,
wherein the control circuit obtains information that represents a voltage of the AC power through communication, and grasps the voltage of the AC power based on the obtained information.

17. The power reception device according to claim 11,
wherein the power receiver causes a plurality of coils to be coupled to a plurality of magnetic fields that are generated by the power transmission device and have different phases, and
the voltage of the reception power is a total voltage of power received by the plurality of coils.
